(19) United States
(12) Patent Application Publication
(10) Pub. No.: US 2022/0001898 A1
(43) Pub. Date: Jan. 6, 2022

(54) VEHICULAR ELECTRONIC DEVICE AND OPERATION METHOD THEREOF

(71) Applicant: LG Electronics Inc., Seoul (KR)

(72) Inventors: Hyeonju Bae, Seoul (KR); Taeseok Lee, Seoul (KR); Chaehwan Leem, Seoul (KR); Soonhong Jung, Seoul (KR)

(21) Appl. No.: 16/490,411

(22) PCT Filed: Apr. 30, 2019
(86) PCT No.: PCT/KR2019/005218

§ 371 Date: Aug. 30, 2019

(51) Int. Cl. B60W 60/00; B60W 50/12; B60W 50/02

(52) U.S. Cl. CPC B60W 60/0059; B60W 60/0015; B60W 50/12; B60W 2556/40; B60W 2050/0215; B60W 2556/10; B60W 50/0205

(57) ABSTRACT

Disclosed is a processor configured to provide a first control signal for blocking interworking between a steering wheel and a vehicle wheel upon receiving autonomous driving mode information, and to provide a second control signal for interworking between the steering wheel and the vehicle wheel upon determining whether a reliability of the autonomous driving mode is equal to or less than a reference value.

### TECHNICAL FIELD

The present invention relates to a vehicular electronic device and an operation method thereof.

### BACKGROUND ART

A vehicle is an apparatus that is moved in a desired direction by a user who rides therein. A representative example of a vehicle is an automobile. An autonomous vehicle is a vehicle that autonomously travels without driving manipulation of a human. A vehicle is configured in such a way that a steering wheel for steering input is mechanically or electrically connected to a vehicle wheel and the vehicle wheel is rotated according to rotation of the steering wheel. The steering wheel is also rotated according to rotation of the vehicle wheel. In the case of autonomous driving, rotation of a steering wheel according to rotation of the vehicle wheel is not required, and a user is injured by unpredictable rotation of the steering wheel. In contrast, in the case of manual driving, if a steering wheel and a vehicle wheel are not connected, there is a risk that an accident is likely to occur during a brief interval of conversion manual driving to autonomous driving.

### DISCLOSURE

### Technical Problem

It is an object of the present invention to provide a vehicular electronic device for interworking between a steering wheel and a vehicle wheel prior to conversion to autonomous driving from manual driving.

It is another object of the present invention to provide an operation method of a vehicular electronic device for interworking between a steering wheel and a vehicle wheel prior to conversion to autonomous driving from manual driving.

The technical problems solved by the embodiments are not limited to the above technical problems, and other technical problems which are not described herein will become apparent to those skilled in the art from the following description.

### Technical Solution

In accordance with the present invention, the above and other objects can be accomplished by the provision of a vehicular electronic device including a processor configured to provide a first control signal for blocking interworking between a steering wheel and a vehicle wheel upon receiving autonomous driving mode information, and to provide a second control signal for interworking between the steering wheel and the vehicle wheel upon determining whether a reliability of the autonomous driving mode is equal to or less than a reference value.

The reliability of the autonomous driving mode may be defined as a probability of an accident not occurring while traveling in an autonomous driving mode.

The processor may determine the reliability of the autonomous driving mode based on at least one of map data, state data of a plurality of sensors configured to detect an object around a vehicle, sensing data generated from the sensor, traveling environment data, or traveling history data.

The processor may provide the second control signal upon determining that the map data is not updated for a preset time.

The processor may provide the second control signal upon determining that there is no object for path planning within a preset region in a map.

The processor may provide the second control signal upon determining that at least one of the plurality of sensors fails.

The processor may provide the second control signal upon determining that a factor for determining quality of the sensing data is equal to or less than a reference value.

The processor may provide the second control signal upon determining the vehicle travels in at least one of a parking lot, private land, an off-ramp, a merge lane, an expressway onramp section, a section of unmarked lanes, or a construction section based on position data of the vehicle.

The processor may provide the second control signal upon determining that the vehicle travels in a section without a travel history.

In accordance with another aspect of the present invention, there is provided an operation method of an electronic device, including receiving autonomous driving mode information by at least one processor, providing a first control signal for blocking interworking between a steering wheel and a vehicle wheel by the at least one processor, determining whether a reliability of the autonomous driving mode is equal to or less than a reference value by the at least one processor, and upon determining that the reliability is equal to or less than the reference value, providing a second control signal for interworking between the steering wheel and the vehicle wheel by the at least one processor.

The reliability of the autonomous driving mode may be defined as a probability of an accident not occurring while traveling in an autonomous driving mode.

The determining may include determining the reliability of the autonomous driving mode based on at least one of map data, state data of a plurality of sensors configured to detect an object around a vehicle, sensing data generated from the sensor, or traveling environment data, by the at least one processor.

The determining may include determining the reliability of the autonomous driving mode based on whether the map data is not updated for a preset time.

The determining may include determining the reliability of the autonomous driving mode based on whether there is an object for path planning within a preset region in a map.

The determining may include determining the reliability of the autonomous driving mode based on whether at least one of the plurality of sensors fails.

The determining may include determining the reliability of the autonomous driving mode based on whether a factor for determining quality of the sensing data is equal to or less than a reference value.

The determining may include determining whether the vehicle travels in at least one of a parking lot, private land, an off-ramp, a merge lane, an expressway onramp section, a section of unmarked lanes, or a construction section based on position data of the vehicle.

The determining may include determining whether the vehicle travels in a section without a travel history.

In accordance with another aspect of the present invention, there is provided a vehicular electronic device including a processor configured to provide a first control signal for blocking interworking between a steering wheel and a vehicle wheel upon receiving autonomous driving mode information, and to provide a second control signal for interworking between the steering wheel and the vehicle wheel upon detecting motion for driving from an image acquired by a camera configured to photograph a passenger compartment of a vehicle.

Details of other embodiments are included in a detailed description and drawings.

### Advantageous Effects

According to the above technical solution, the present invention may provide one or more of the following effects.

First, a steering wheel and a vehicle wheel are connected to each other prior to conversion to a manual driving mode from an autonomous driving mode, and thus a user may be capable of performing steering input without delay after conversion to manual driving.

Second, a traffic accident that may occur upon conversion from an autonomous driving mode to a manual driving mode may be prevented.

The effects of the present invention are not limited to the above-described effects and other effects which are not described herein may be derived by those skilled in the art from the following description of the embodiments of the disclosure.

### DESCRIPTION OF DRAWINGS

FIG. 1 is a diagram showing an outer appearance of a vehicle according to an embodiment of the present invention.

FIG. 2 is a control block diagram of a vehicle according to an embodiment of the present invention.

FIG. 3 is a diagram showing a passenger compartment of a vehicle according to an embodiment of the present invention.

FIG. 4 is a control block diagram of an electronic device according to an embodiment of the present invention.

FIGS. 5 and 6 are flowcharts of an electronic device according to an embodiment of the present invention.

FIGS. 7 to 10 are diagrams for explanation of an operation of an electronic device according to an embodiment of the present invention.

### BEST MODE

Reference will now be made in detail to the exemplary embodiments of the present invention, examples of which are illustrated in the accompanying drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms “first”, “second”, “third” etc. may be used herein to describe various elements, these elements should not be limited by these terms. These terms are only used to distinguish one element from another element.

It will be understood that when an element is referred to as being “on”, “connected to” or “coupled to” another element, it may be directly on, connected or coupled to the other element, or intervening elements may be present. In contrast, when an element is referred to as being “directly on,” “directly connected to” or “directly coupled to” another element or layer, there are no intervening elements present.

The singular expressions in the present specification include the plural expressions unless clearly specified otherwise in context.

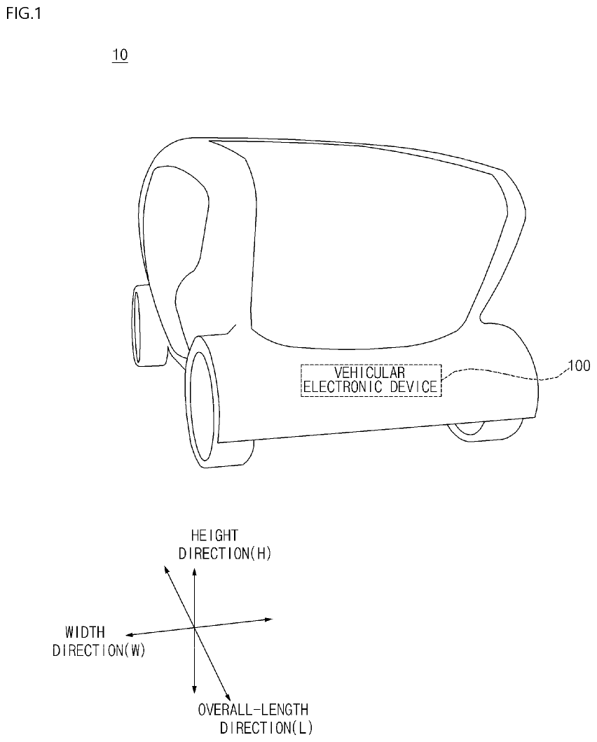

It will be further understood that the terms “comprises” or “comprising” when used in this specification specify the presence of stated features, integers, steps, operations, elements, or components, but do not preclude the presence or addition of one or more other features, integers, steps, operations, elements, components, or groups thereof. FIG. 1 is a diagram showing a vehicle according to an embodiment of the present invention.

Referring to FIG. 1, a vehicle 10 according to an embodiment of the present invention may be defined as a transportation device that travels on a road or a railroad. The vehicle 10 may conceptually include an automobile, a train, and a motorcycle. The vehicle 10 may include a vehicle equipped with an internal combustion engine as a power source, a hybrid vehicle equipped with both an engine and an electric motor as a power source, and an electric vehicle equipped with an electric motor as a power source. The vehicle 10 may be an autonomous vehicle.

The vehicle 10 may include a vehicular electronic device 100. The vehicular electronic device 100 may receive autonomous driving mode information (e.g., information on conversion to an autonomous driving mode) and manual driving mode information (e.g., information on conversion to a manual driving mode) from other electronic devices inside the vehicle 10. Upon receiving the autonomous driving mode information, the vehicular electronic device 100 may block interworking between a steering wheel and a vehicle wheel. Upon receiving the manual driving mode information, the vehicular electronic device 100 may perform interworking between the steering wheel and the vehicle wheel. The interworking between the steering wheel and the vehicle wheel may be mechanical interworking or electrical interworking.

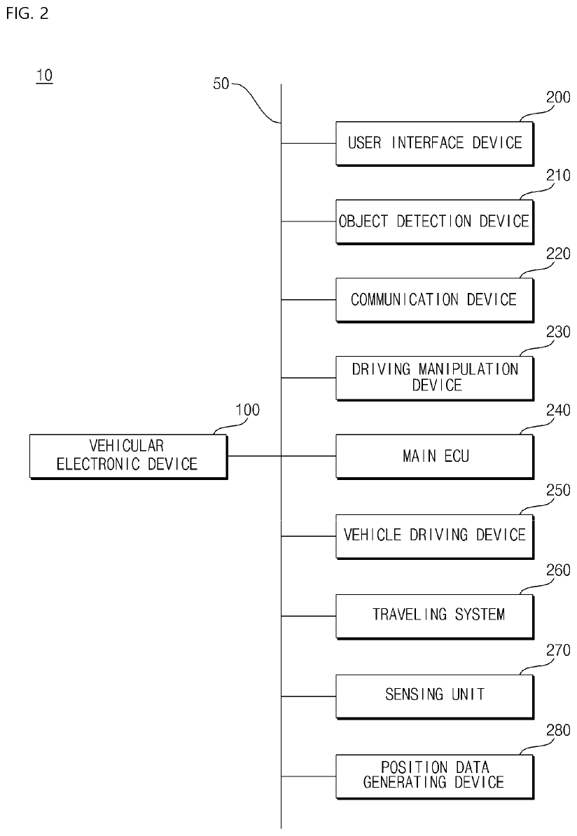

FIG. 2 is a control block diagram of a vehicle according to an embodiment of the present invention.

Referring to FIG. 2, the vehicle 10 may include the vehicular electronic device 100, a user interface device 200, an object detection device 210, a communication device 220, a driving manipulation device 230, a main electronic control unit (ECU) 240, a vehicle driving device 250, a traveling system 260, a sensing unit 270, and a position data generating device 280.

The vehicular electronic device 100 may receive autonomous driving mode information and manual driving mode information from other electronic devices in the vehicle 10. The vehicular electronic device 100 may receive information on conversion to an autonomous driving mode from a manual driving mode. The vehicular electronic device 100 may receive information on conversion to the manual driving mode from the autonomous driving mode. The vehicular electronic device 100 may generate a control signal based on the received information. The vehicular electronic device 100 may provide a control signal for blocking interworking between the steering wheel and the vehicle wheel. The vehicular electronic device 100 may provide a control signal for interworking between the steering wheel and the vehicle wheel.

The UI device 200 may be used to enable the vehicle 10 to communicate with a user. The UI device 200 may receive user input, and may provide information generated by the vehicle 10 to the user. The vehicle 10 may implement a UI or User Experience (UX) through the UI device 200.

The object detection device 210 may detect an object outside the vehicle 10. The object detection device 210 may include at least one of a camera, radio detecting and ranging (radar), light detection and ranging (LiDAR), an ultrasonic sensor, or an infrared sensor. The object detection device 210 may provide data of an object, which is generated based on a sensing signal generated by a sensor, to at least one electronic device included in a vehicle.

The communication device 220 may exchange a signal with a device positioned outside the vehicle 10. The communication device 220 may exchange a signal with at least one of an infrastructure element (e.g., a server or a broadcast station) or other vehicles. The communication device 220 may include at least one of a transmission antenna, a reception antenna, a radio frequency (RF) circuit for implementing various communication protocols, or an RF device for performing communication.

The driving manipulation device 230 may be used to receive a user command for driving the vehicle 10. In the manual mode, the vehicle 10 may travel based on a signal provided by the driving manipulation device 230. The driving manipulation device 230 may include a steering input device (e.g., a steering wheel), an acceleration input device (e.g., an acceleration pedal), and a brake input device (e.g., a brake pedal).

The main ECU 240 may control an overall operation of at least one electronic device included inside the vehicle 10.

The vehicle driving device 250 is a device for electrically controlling various devices inside the vehicle 10. The vehicle driving device 250 may include a powertrain driving unit, a chassis driving unit, a door/window driving unit, a safety device driving unit, a lamp driving unit, and an air conditioner driving unit. The powertrain driving unit may include a power source driver and a transmission driver. The chassis driving unit may include a steering driver, a brake driver, and a suspension driver.

The safety device driving unit may include a seatbelt driver for control of a seatbelt.

An advanced driver assistance system (ADAS) 260 may generate a signal for controlling the movement of the vehicle 10 or for outputting information to a user, based on the data of the object, which is received from the object detection device 210. The ADAS 260 may provide the generated signal to at least one of the user interface device 200, the main ECU 240, or the vehicle driving device 250.

The ADAS 260 may implement at least one of an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, a high beam assist (HBA) system, an auto parking system (APS), a PD collision warning system, a traffic sign recognition (TSR) system, a traffic sign assist (TSA) system, a night vision (NV) system, a driver status monitoring (DSM) system, or a traffic jam assist (TJA) system.

The sensing unit 270 may sense a vehicle state. The sensing unit 270 may include at least one of an inertial navigation unit (IMU) sensor, a collision sensor, a wheel sensor, a speed sensor, an inclination sensor, a weight detection sensor, a heading sensor, a position module, a vehicle drive/reverse sensor, a battery sensor, a fuel sensor, a tire sensor, a steering sensor for rotation of the steering wheel, an in-vehicle temperature sensor, an in-vehicle humidity sensor, an ultrasonic sensor, an illuminance sensor, an acceleration pedal position sensor, or a brake pedal position sensor. The inertial navigation unit (IMU) sensor may include one or more of an acceleration sensor, a gyro sensor, and a magnetic sensor.

The sensing unit 270 may generate state data of a vehicle based on a signal generated by at least one sensor. The sensing unit 270 may acquire a sensing signal of vehicle position information, vehicle motion information, vehicle yaw information, vehicle roll information, vehicle pitch information, vehicle collision information, vehicle heading information, vehicle angle information, vehicle speed information, vehicle acceleration information, vehicle inclination information, vehicle drive/reverse information, battery information, fuel information, wheel information, vehicle lamp information, vehicle internal temperature information, vehicle internal humidity information, a steering wheel rotation angle, a vehicle external illuminance, the pressure applied to an accelerator pedal, the pressure applied to a brake pedal, and so on.

The sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a top dead center (TDC) sensor, a crank angle sensor (CAS), and so on.

The sensing unit 270 may generate vehicle state information based on the sensing data. The vehicle state information may be generated based on data detected by various sensors included in the vehicle.

For example, the vehicle state information may include vehicle position information, vehicle speed information, vehicle inclination information, vehicle weight information, vehicle heading information, vehicle battery information, vehicle fuel information, vehicle wheel air pressure information, vehicle steering information, in-vehicle temperature information, in-vehicle humidity information, pedal position information, vehicle engine temperature information, and so on.

The sensing unit may include a tension sensor. The tension sensor may generate a sensing signal based on a tension state of a seatbelt.

The position data generating device 280 may generate position data of the vehicle 10. The position data generating device 280 may include at least one of a global positioning system (GPS) or a differential global positioning system (DGPS). The position data generating device 280 may generate position data of the vehicle 10 based on a signal generated by at least one of a GPS or a DGPS. In some embodiments, the position data generating device 280 may correct the position data based on at least one of an inertial measurement unit (IMU) of the sensing unit 270 or a camera of the object detection device 210. The vehicle 10 may include an internal communication system 50. A plurality of electronic devices included in the vehicle 10 may exchange signals using the internal communication system 50 as a medium. The signals may include data. The internal communication system 50 may use at least one communication protocol (e.g., CAN, LIN, FlexRay, MOST, or Ethernet).

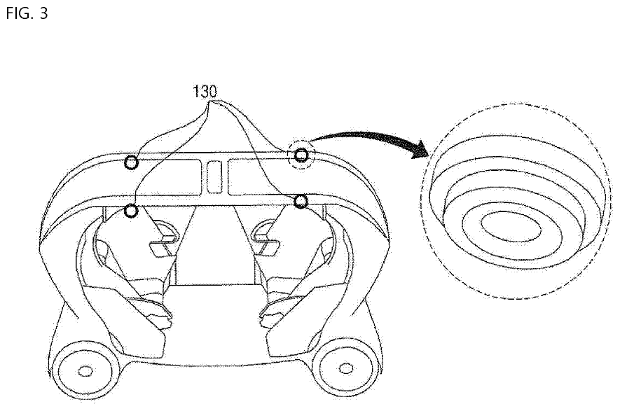

FIG. 3 is a diagram showing a passenger compartment of a vehicle according to an embodiment of the present invention.

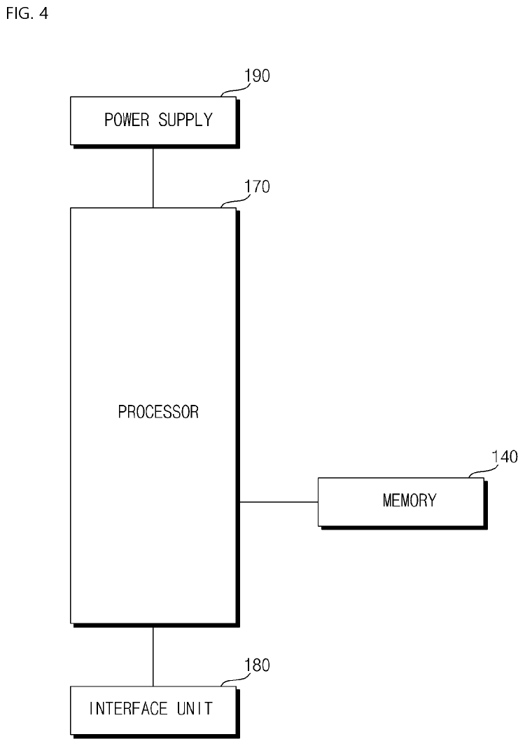

FIG. 4 is a control block diagram of an electronic device according to an embodiment of the present invention.

Referring to FIGS. 3 and 4, the electronic device 100 may include a memory 140, a processor 170, an interface unit 180, and a power supply 190.

The memory 140 may be electrically connected to the processor 170. The memory 140 may store basic data of a predetermined unit, control data for control of an operation of a predetermined unit, and input and output data. The memory 140 may store data processed by the processor 170. The memory 140 may include at least one of a read-only memory (ROM), random-access memory (RAM), erasable programmable read only memory (EPROM), flash drive, or hard drive in terms of hardware. The memory 140 may store various data for an overall operation of the electronic device 100, such as a program for processing or controlling the processor 170. The memory 140 may be integrated into the processor 170. In some embodiments, the memory 140 may be classified as a lower-ranking component of the processor 170.

The memory 140 may store image data generated by a camera 130. When the processor 170 determines that a second user invades a virtual barrier, the memory 140 may store image data as a reference for determination.

The interface unit 180 may exchange a signal in a wired or wireless manner with at least one electronic device included in the vehicle 10. The interface unit 180 may exchange a signal in a wired or wireless manner with at least one of the object detection device 210, the communication device 220, the driving manipulation device 230, the main ECU 240, the vehicle driving device 250, the ADAS 260, the sensing unit 270 or the position data generating device 280. The interface unit 180 may include at least one of a communication module, a terminal, a pin, a cable, a port, a circuit, an element, or a device.

The interface unit 180 may receive position data of the vehicle 10 from the position data generating device 280. The interface unit 180 may receive traveling speed data from the sensing unit 270. The interface unit 180 may receive data of an object around a vehicle from the object detection device 210.

The power supply 190 may supply power to the electronic device 100. The power supply 190 may receive power from a power source (e.g., a battery) included in the vehicle 10 and may supply power to each unit of the electronic device 100. The power supply 190 may be operated according to a control signal provided from the main ECU 240. The power supply 190 may be embodied as a switched-mode power supply (SMPS).

The processor 170 may be electrically connected to the memory 140, the interface unit 180, and the power supply 190 and may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or an electronic unit for performing other functions.

The processor 170 may be driven by power supplied from the power supply 190. The processor 170 may receive data, may process the data, may generate a signal, and may provide a signal in a state in which power is supplied by the power supply 190.

The processor 170 may receive information from other electronic devices within the vehicle 10 through the interface unit 180. The processor 170 may provide a control signal to other electronic devices within the vehicle 10 through the interface unit 180.

The processor 170 may receive autonomous driving mode information. For example, the processor 170 may receive information on conversion to an autonomous driving mode from a manual driving mode. For example, the processor 170 may receive autonomous driving mode information from the main ECU 240 or the traveling system 260. Upon receiving the autonomous driving mode information, the processor 170 may provide a first control signal for blocking interworking between the steering wheel and the vehicle wheel. The first control signal may be provided to at least one of the driving manipulation device 230, the main ECU 240, the vehicle driving device 250, or the traveling system 260. When the vehicle 10 is converted to the autonomous driving mode from the manual driving mode, if a user takes his or her hand off the steering wheel, the steering wheel and the vehicle wheel interwork with each other for a preset time, and after the preset time elapses, interworking between the steering wheel and the vehicle wheel may be blocked as conversion to the autonomous driving mode is completed. When interworking between the steering wheel and the vehicle wheel is blocked, the processor 170 may provide a control signal for outputting information on blocking of interworking to the user interface device 200.

The processor 170 may determine whether the reliability of an autonomous driving mode is equal to or less than a reference value. The reliability of the autonomous driving mode may be defined as the probability of an accident not occurring while traveling in the autonomous driving mode. The processor 170 may classify the reliability of the autonomous driving mode into high and low levels depending on whether the probability of an accident occurring is equal to or greater than the reference value or is less than the reference value. The high level of the reliability of the autonomous driving mode may be defined as a state in which it is possible to maintain autonomous driving, and the low level of the autonomous driving mode may be defined as a state in which it is not possible to maintain autonomous driving.

The processor 170 may determine the reliability of the autonomous driving mode based on at least one of map data, state data of a plurality of sensors for detecting an object around a vehicle, sensing data and traveling environment data generated by the plurality of sensors, or traveling history data. The plurality of sensors may be defined as sensors included in the object detection device 210.

Upon determining that the reliability of the autonomous driving mode is equal to or less than the reference value, the processor 170 may provide a second control signal for interworking between the steering wheel and the vehicle wheel. When the reliability of the autonomous driving mode is low, the processor 170 may perform interworking between the steering wheel and the vehicle wheel.

For example, upon determining that the map data is not updated for a preset time or greater, the processor 170 may provide a second control signal. Upon determining that the map data is not updated for a preset time or greater, the processor 170 may determine the reliability of the autonomous driving mode to be low. In this case, the processor 170 may provide the second control signal.

For example, upon determining that there is no object for path planning of the vehicle 10 within a preset region in a map, the processor 170 may provide the second control signal. Upon determining that there is no object for path planning within a preset radius in the map data based on the current position of the vehicle 10, the processor 170 may determine the reliability of the autonomous driving mode to be low. In this case, the processor 170 may provide the second control signal. The object for path planning may include at least one of a traffic light, a sign, a building, a lane, or an intersection.

For example, upon determining that at least one of the plurality of sensors fails, the processor 170 may provide the second control signal. Upon determining that at least one of a camera, a radar, a LiDAR, an ultrasonic sensor, or an infrared sensor for detecting an object outside the vehicle 10 fails, the processor 170 may determine the reliability of the autonomous driving mode to be low. In this case, the processor 170 may provide the second control signal.

For example, upon determining that a factor for determining the quality of sensing data received from at least one of the plurality of sensors is equal to or less than a reference value, the processor 170 may provide the second control signal. Upon determining that the quality of the sensing data received from at least one of a camera, a radar, a LiDAR, an ultrasonic sensor, and an infrared sensor for detecting an object outside the vehicle 10 is low, the processor 170 may determine the reliability of the autonomous driving mode to be low. In this case, the processor 170 may provide the second control signal. For example, when sensing data generated by at least one of the plurality of sensors is affected by noise, the processor 170 may provide the second control signal.

For example, upon determining that the vehicle 10 travels in at least one a parking lot, private land, an off-ramp, a merge lane, an expressway onramp section, a section of unmarked lanes, or a construction section based on position data of the vehicle 10, the processor 170 may provide the second control signal.

For example, upon determining that the vehicle 10 travels in a situation in which it rains, it snows, or it is foggy, the processor 170 may provide the second control signal.

For example, upon determining that the vehicle 10 travels in a section without a travel history, the processor 170 may provide the second control signal.

Upon detecting motion for driving from an image acquired from a camera for photographing a passenger compartment of a vehicle, the processor 170 may provide the second control signal for interworking between the steering wheel and the vehicle wheel.

Upon detecting motion for raising a laid seat or motion for changing seat directed backwards in a forward direction, the processor 170 may provide the second control signal. The processor 170 may provide the second control signal in further consideration of a signal that is generated by pressing an acceleration pedal or a brake pedal by a user. When the vehicle 10 is converted to a manual driving mode from an autonomous driving mode, the processor 170 may provide a control signal to the user interface device 200 depending on a state of the user. For example, upon determining that it is not clear whether the user state is a state in which the user is capable of driving a vehicle, the processor 170 may provide a control signal for outputting notification through vibration or sound. For example, upon determining that the user state is a state in which the user is capable of driving a vehicle, the processor 170 may provide a control signal for outputting notification indicating that state conversion is not possible through visual, audible, and tactile sensation.

The vehicle 10 may further include an internal camera for photographing a passenger compartment of a vehicle. The processor 170 may receive image data of the passenger compartment of the vehicle from the internal camera. The processor 170 may determine intention to drive of a user based on the image data of the passenger compartment. For example, upon detecting motion for raising a laid seat or motion for changing seat directed backwards in a forward direction, the processor 170 may determine that the user has intention to drive.

The electronic device 100 may include at least one printed circuit board (PCB). The memory 140, the interface unit 180, the power supply 190, and the processor 170 may be electrically connected to the PCB.

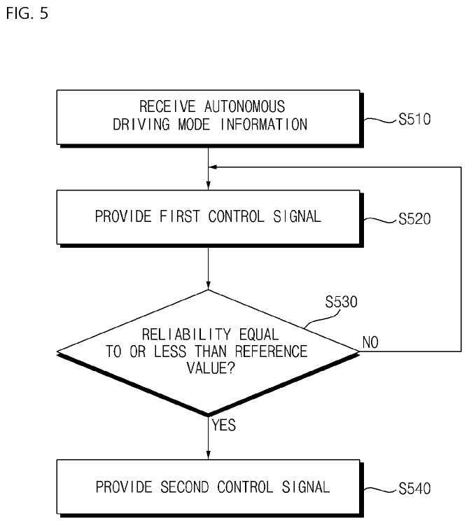

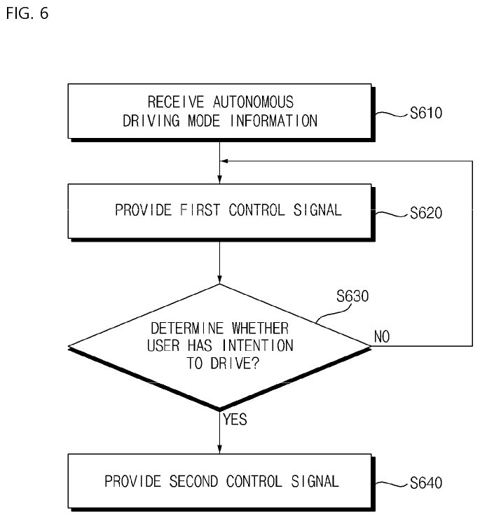

FIGS. 5 and 6 are flowcharts of an electronic device according to an embodiment of the present invention. FIGS. 5 and 6 show an example of each of operations S500 and S600 of the electronic device 100 included in the vehicle 10.

Referring to FIG. 5, the processor 170 may receive autonomous driving mode information through the interface unit 180 (S510). For example, the processor 170 may receive information on conversion to an autonomous driving mode from a manual driving mode.

Upon receiving the autonomous driving mode information the processor 170 may provide a first control signal for blocking interworking between the steering wheel and the vehicle wheel (S520). The processor 170 may provide the first control signal to at least one of the driving manipulation device 230, the main ECU 240, the vehicle driving device 250, or the traveling system 260.

The processor 170 may determine whether the reliability of the autonomous driving mode is equal to or less than a reference value (S530). The reliability of the autonomous driving mode may be defined as the probability of an accident not occurring while traveling in the autonomous driving mode. The processor 170 may classify the reliability of the autonomous driving mode into high and low levels depending on whether the probability of an accident occurring is equal to or greater than the reference value or is less than the reference value. The high level of the reliability of the autonomous driving mode may be defined as a state in which it is possible to maintain autonomous driving, and the low level of the reliability of the autonomous driving mode may be defined as a state in which it is not possible to maintain autonomous driving.

In the determining (S530), the processor 170 may determine the reliability of the autonomous driving mode based on at least one of map data, state data of a plurality of sensors for detecting an object around a vehicle, or sensing data or traveling environment data generated by the sensors. The plurality of sensors may be defined as sensors included in the object detection device 210.

For example, in the determining (S530), the processor 170 may determine the reliability of the autonomous driving mode depending on whether the map data is not updated for a preset time or greater. Upon determining that the map data is not updated for a preset time or greater, the processor 170 may determine that the reliability of the autonomous driving mode is equal to or less than the reference value.

For example, in the determining (S530), the processor 170 may determine the reliability of the autonomous driving mode based on whether there is an object for path planning within a preset region in a map. Upon determining that there is no object for path planning within a preset radius in the map data based on a current position of the vehicle 10, the processor 170 may determine the reliability of the autonomous driving mode to be low.

For example, in the determining (S530), upon determining that at least one of the plurality of sensors fails, the processor 170 may determine the reliability of the autonomous driving mode based on whether at least one of the plurality of sensors fails. Upon determining that at least one of a camera, a radar, a LiDAR, an ultrasonic sensor, or an infrared sensor for detecting an object outside the vehicle 10 fails, the processor 170 may determine that the reliability of the autonomous driving mode is equal to or less than the reference value.

For example, in the determining (S530), upon determining that a factor for determining the quality of sensing data is equal to or less than a reference value, the processor 170 may determine the reliability of the autonomous driving mode based on whether the factor for determining the quality of sensing data is equal to or less than the reference value. Upon determining that the quality of the sensing data received from at least one of a camera, a radar, a LiDAR, an ultrasonic sensor, and an infrared sensor for detecting an object outside the vehicle 10 is low, the processor 170 may determine that the reliability of the autonomous driving mode is equal to or less than the reference value.

For example, in the determining (S530), the processor 170 may determine whether a vehicle travels in at least one a parking lot, private land, an off-ramp, a merge lane, an expressway onramp section, a section of unmarked lanes, or a construction section based on position data of the vehicle 10.

For example, in the determining (S530), the processor 170 may determine whether the vehicle 10 travels in a section without a travel history.

Upon determining that the reliability of the autonomous driving mode is equal to or less than the reference value, the processor 170 may provide the second control signal for interworking between the steering wheel and the vehicle wheel (S540).

Referring to FIG. 6, the processor 170 may receive autonomous driving mode information through the interface unit 180 (S610). For example, the processor 170 may receive information on conversion to an autonomous driving mode from a manual driving mode.

Upon receiving the autonomous driving mode information, the processor 170 may provide a first control signal for blocking interworking between the steering wheel and the vehicle wheel (S620). The processor 170 may provide the first control signal to at least one of the driving manipulation device 230, the main ECU 240, the vehicle driving device 250, or the traveling system 260.

The processor 170 may determine whether a user has intention to drive (S630). The vehicle 10 may further include an internal camera for photographing a passenger compartment of a vehicle. The processor 170 may receive image data of the passenger compartment of the vehicle from the internal camera. The processor 170 may determine the intention to drive of a user based on the image data of the passenger compartment. For example, upon detecting motion for raising a laid seat or motion for changing seat directed backwards in a forward direction, the processor 170 may determine that the user has intention to drive.

Upon determining that the user has intention to drive, the processor 170 may provide a second control signal for interworking between the steering wheel and the vehicle wheel (S640).

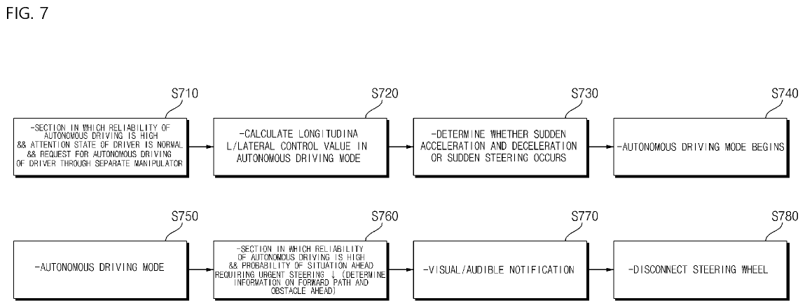

FIGS. 7 to 10 are diagrams for explanation of the operation of an electronic device according to an embodiment of the present invention.

Referring to FIG. 7, at least one electronic device included in the vehicle 10 may determine whether the vehicle 10 travels in a traveling section in which the reliability of the autonomous driving mode is high, whether an attention state of a user is a normal state, and whether a request for conversion to an autonomous driving mode is received from a user (S710).

At least one electronic device included in the vehicle 10 may calculate a longitudinal-direction control value and a lateral-direction control value in the autonomous driving mode (S720).

At least one electronic device included in the vehicle may determine whether sudden acceleration, sudden deceleration, or sudden steering occurs (S730).

When the conditions of operations S710, S720, and S730 are satisfied, at least one electronic device included in the vehicle 10 may start the autonomous driving mode (S740).

In a state in which the vehicle 10 travels in the autonomous driving mode (S750), the processor 170 may determine that the vehicle 10 travels in a section in which autonomous driving reliability is high and the probability of a situation ahead requiring urgent steering is low (S760).

The processor 170 may determine the probability of a situation ahead requiring urgent steering based on a forward path and obstacles ahead of a vehicle.

The processor 170 may provide a control signal for outputting information indicating that the steering wheel and the vehicle wheel are supposed to be disconnected from each other, to the user interface device 200 (S770).

The processor 170 may provide the first control signal for blocking interworking between the steering wheel and the vehicle wheel (S780).

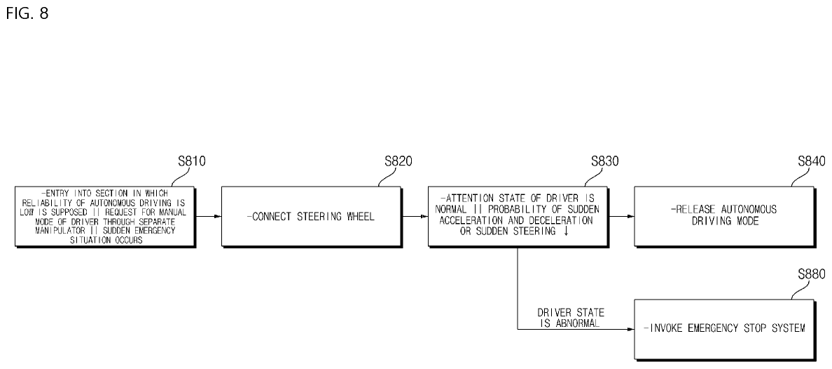

Referring to FIG. 8, the processor 170 may determine whether a vehicle in an autonomous driving mode is supposed to enter a section with low reliability, whether a request for manual driving is received from a user, or whether a sudden emergency situation occurs (S810).

The processor 170 may provide a second control signal for interworking between the steering wheel and the vehicle wheel (S820).

At least one electronic device included in the vehicle 10 may determine that an attention state of a user is a normal state, and that the probability of a situation ahead requiring sudden acceleration, sudden deceleration, or sudden steering is low (S830).

At least one electronic device included in the vehicle 10 may release the autonomous driving mode and may convert the current mode to a manual driving mode (S840).

Upon determining the attention state of the user to be abnormal in operation S830, at least one electronic device included in the vehicle 10 may invoke an emergency stop system.

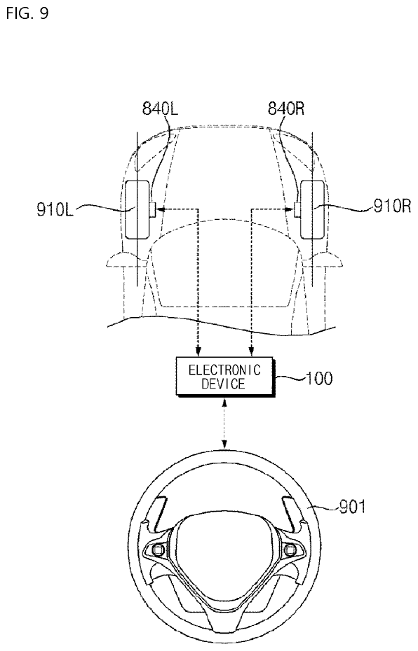

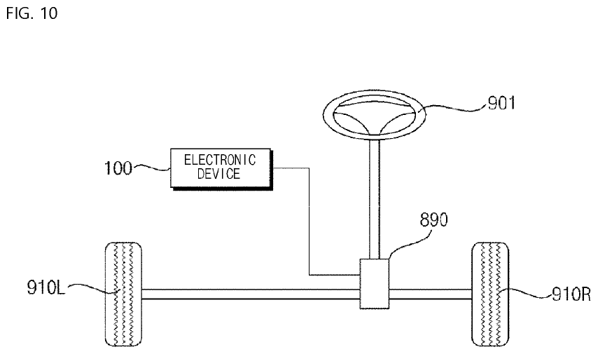

FIGS. 9 and 10 are diagrams for explanation of interworking between a steering wheel 901 and vehicle wheels 910L and 910R and blocking thereof according to an embodiment of the present invention.

FIG. 9 shows an example of electrical interworking between the steering wheel 901 and the vehicle wheels 910L and 910R and blocking thereof. FIG. 10 shows an example of mechanical interworking between the steering wheel 901 and the vehicle wheels 910L and 910R and blocking thereof.

Referring to FIG. 9, the electronic device 100 may provide a first control signal for blocking electrical interworking between the steering wheel 901 and the vehicle wheels 910L and 910R when autonomous driving mode information is received. When the first control signal is received from the electronic device 100, interworking between the steering wheel 901 and the vehicle wheels 910L and 910R may be blocked. In this case, even if a direction of the vehicle wheels 910L and 910R is changed, the steering wheel 901 may not be rotated, and even if the steering wheel 901 is rotated, a direction of the vehicle wheels 910L and 910R is not changed.

According to determination of the reliability of the autonomous driving mode, the electronic device 100 may provide a second control signal for interworking between the steering wheel 901 and the vehicle wheels 910L and 910R. When the second control signal is received from the electronic device 100, the steering wheel 901 and the vehicle wheels 910L and 910R may be electrically connected. In this case, when a direction of the vehicle wheels 910L and 910R is changed, the steering wheel 901 may be rotated, and even if the steering wheel 901 is rotated, a direction of the vehicle wheels 910L and 910R may be changed.

Referring to FIG. 10, the steering wheel 901 may mechanically interwork with the vehicle wheels 910L and 910R.

For example, the steering wheel 901 and the vehicle wheels 910L and 910R may mechanically interwork with each other while a steering shaft, a steering gear box, a pitman arm, a drag link, a center link, a tie-rod, a knuckle arm, a steering knuckle, a kingpin, or the like is disposed therebetween. Here, each unit disposed between the steering wheel 901 and the vehicle wheels 910L and 910R may be omitted or another unit may be added in some embodiments.

The vehicle 10 may further include a clutch 890. Here, the clutch 890 may regulate the power transferred to the vehicle wheels 910L and 910R from the steering wheel 901 according to control of the electronic device 100.

Upon receiving the autonomous driving mode information, the electronic device 100 may provide a first control signal for blocking mechanical interworking between the steering wheel 901 and the vehicle wheels 910L and 910R. When a signal based on the first control signal is received by the clutch 890, mechanical interworking between the steering wheel 901 and the vehicle wheels 910L and 910R may be blocked. In this case, even if a direction of the vehicle wheels 910L and 910R is changed, the steering wheel 901 may not be rotated, and even if the steering wheel 901 is rotated, a direction of the vehicle wheels 910L and 910R may not be changed.

According to determination of the reliability of the autonomous driving mode, the electronic device 100 may provide a second control signal for mechanical interworking between the steering wheel 901 and the vehicle wheels 910L and 910R. When a signal based on the second control signal is received by the clutch 890, the steering wheel 901 and the vehicle wheels 910L and 910R may be mechanically connected to each other. In this case, when a direction of the vehicle wheels 910L and 910R is changed, the steering wheel 901 may be rotated, and even if the steering wheel 901 is rotated, a direction of the vehicle wheels 910L and 910R is changed.

When interworking between the steering wheel 901 and the vehicle wheels 910L and 910R is blocked, the user interface device 200 for a vehicle may provide an interface for a game, or an interface for driving practice simulation. In this case, the user may play a game or may practice driving using the steering wheel 901.

Interworking between the steering wheel 901 and the vehicle wheels 910L and 910R may be basically blocked in the autonomous driving mode of the vehicle 10, but in a specific situation, the interworking may be maintained. Even if the vehicle 10 is in an autonomous driving mode, the processor 170 may provide a control signal to maintain interworking between the steering wheel 901 and the vehicle wheels 910L and 910R in a specific situation. For example, the processor 170 may provide a control signal to maintain interworking between the steering wheel 901 and the vehicle wheels 910L and 910R for a preset time at the beginning of entry into the autonomous driving mode or immediately prior to release from the autonomous driving mode. For example, the processor 170 may provide a control signal to maintain interworking between the steering wheel 901 and the vehicle wheels 910L and 910R in a situation in which the reliability of the autonomous driving mode is not clear. For example, when the vehicle 10 travels in a spot in which accidents frequently occur or an accident has taken, the processor 170 may provide a control signal to maintain interworking between the steering wheel 901 and the vehicle wheels 910L and 910R.

Even in a state in which interworking between the steering wheel 901 and the vehicle wheels 910L and 910R is blocked in the autonomous driving mode of the vehicle 10, cooperative control with a user may be enabled. For example, when an emergency situation occurs and an attention state of the user is normal, the processor 170 may provide a manipulation value of the steering wheel of the user to at least one electronic device (e.g., the main ECU 240, the vehicle driving device 250, or the traveling system 260) included in the vehicle 10 irrespective of whether the steering wheel 901 and the vehicle wheels 910L and 910R interwork with each other. The emergency situation may be determined by the processor 170 based on at least one of a time to collision (TTC), time headway (THW), whether an accident occurs, or whether a system fails. For example, when the reliability of the autonomous driving mode is increased to a high level from a low level, the processor 170 may provide a manipulation value of the steering wheel of the user to at least one electronic device (e.g., the main ECU 240, the vehicle driving device 250, or the traveling system 260) included in the vehicle 10 irrespective of whether the steering wheel 901 and the vehicle wheels 910L and 910R interwork with each other.

The invention can also be embodied as computer readable code on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), ROM, RAM, CD-ROM, magnetic tapes, floppy disks, optical data storage devices, etc. and include a carrier wave (for example, a transmission over the Internet). In addition, the computer may include a processor or a controller. Accordingly, it will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### DESCRIPTION OF REFERENCE NUMERAL

10: vehicle
100: vehicular electronic device

What is claimed:

1. A vehicular electronic device comprising:
a processor configured to provide a first control signal for blocking interworking between a steering wheel and a vehicle wheel upon receiving autonomous driving mode information, and to provide a second control signal for interworking between the steering wheel and the vehicle wheel upon determining whether a reliability of the autonomous driving mode is equal to or less than a reference value.

2. The vehicular electronic device of claim 1, wherein the reliability of the autonomous driving mode is defined as a probability of an accident not occurring while traveling in an autonomous driving mode.

3. The vehicular electronic device of claim 1, wherein the processor determines the reliability of the autonomous driving mode based on at least one of map data, state data of a plurality of sensors configured to detect an object around a vehicle, sensing data generated from the sensor, traveling environment data, or traveling history data.

4. The vehicular electronic device of claim 3, wherein the processor provides the second control signal upon determining that the map data is not updated for a preset time.

5. The vehicular electronic device of claim 3, wherein the processor provides the second control signal upon determining that there is no object for path planning within a preset region in a map.

6. The vehicular electronic device of claim 3, wherein the processor provides the second control signal upon determining that at least one of the plurality of sensors fails.

7. The vehicular electronic device of claim 3, wherein the processor provides the second control signal upon determining that a factor for determining quality of the sensing data is equal to or less than a reference value.

8. The vehicular electronic device of claim 3, wherein the processor provides the second control signal upon determining the vehicle travels in at least one of a parking lot, private land, an off-ramp, a merge lane, an expressway onramp section, a section of unmarked lanes, or a construction section based on position data of the vehicle.

9. The vehicular electronic device of claim 3, wherein the processor provides the second control signal upon determining that the vehicle travels in a section without a travel history.

10. An operation method of an electronic device, the method comprising:
receiving autonomous driving mode information by at least one processor;
providing a first control signal for blocking interworking between a steering wheel and a vehicle wheel by the at least one processor;
determining whether a reliability of the autonomous driving mode is equal to or less than a reference value by the at least one processor; and
upon determining that the reliability is equal to or less than the reference value, providing a second control signal for interworking between the steering wheel and the vehicle wheel by the at least one processor.

11. The method of claim 10, wherein the reliability of the autonomous driving mode is defined as a probability of an accident not occurring while traveling in an autonomous driving mode.

12. The method of claim 10, wherein the determining includes determining the reliability of the autonomous driving mode based on at least one of map data, state data of a plurality of sensors configured to detect an object around a vehicle, sensing data generated from the sensor, or traveling environment data, by the at least one processor.

13. The method of claim 12, wherein the determining includes determining the reliability of the autonomous driving mode based on whether the map data is not updated for a preset time.

14. The method of claim 12, wherein the determining includes determining the reliability of the autonomous driving mode based on whether there is an object for path planning within a preset region in a map.

15. The method of claim 12, wherein the determining includes determining the reliability of the autonomous driving mode based on whether at least one of the plurality of sensors fails.

16. The method of claim 12, wherein the determining includes determining the reliability of the autonomous driving mode based on whether a factor for determining quality of the sensing data is equal to or less than a reference value.

17. The method of claim 12, wherein the determining includes determining whether the vehicle travels in at least one of a parking lot, private land, an off-ramp, a merge lane, an expressway onramp section, a section of unmarked lanes, or a construction section based on position data of the vehicle.

18. The method of claim 12, wherein the determining includes determining whether the vehicle travels in a section without a travel history.

19. A vehicular electronic device comprising:
a processor configured to provide a first control signal for blocking interworking between a steering wheel and a vehicle wheel upon receiving autonomous driving mode information, and to provide a second control signal for interworking between the steering wheel and the vehicle wheel upon detecting motion for driving from an image acquired by a camera configured to photograph a passenger compartment of a vehicle.

20. The vehicular electronic device of claim 19, wherein the processor provides the second control signal upon detecting motion for raising a laid seat or motion for changing seat directed backwards in a forward direction.
